(19) United States
(12) Patent Application Publication
(10) Pub. No.: US 2026/0252791 A1
(43) Pub. Date: Aug. 27, 2026

(54) ATTRIBUTION IN CONTEXTUAL QUESTION ANSWERING USING MACHINE-LEARNING HIDDEN STATES

(71) Applicant: Adobe Inc., San Jose, CA (US)

(72) Inventors: Anirudh Phukan, Bengaluru (IN); Koustava Goswami, Bengaluru (IN); Apoorv Umang Saxena, Bangalore (IN); Animesh Kumar, Patna (IN)

(73) Assignee: Adobe Inc., San Jose, CA (US)

(21) Appl. No.: 19/065,659

(22) Filed: Feb. 27, 2025

(51) Int. Cl. G06F 40/169; G06F 40/117; G06F 40/284; G06F 40/40

(52) U.S. Cl. CPC G06F 40/169; G06F 40/117; G06F 40/284; G06F 40/40

(57) ABSTRACT

In accordance with the described techniques for attribution in contextual question answering using large-language-model hidden states, a processing device receives a document and an answer formulated by a first machine-learning model from the content of the document. A second machine-learning model decomposes the answer into one or more answer tokens and attributes each answer token to one or more document tokens of the document. The processing device then generates an annotated document that includes at least one visual indication associating one or more answer tokens with one or more document tokens.

### BACKGROUND

Generative artificial intelligence (AI) improves efficiency for many content generation and review tasks. For example, large language models (LLMs) generate answers to questions or prompts by taking information from various sources, summarizing and synthesizing the information, and providing an answer to the user in a natural language format. Given an appropriate prompt, LLMs automatically generate textual content, such as product descriptions, reports, summaries, answers, and customer support responses. However, when LLMs are used for contextual question answering, the output answer generally does not indicate the input source document(s) or will include text copied verbatim from the input prompt linked together with filler text, undercutting the user's trust in the generated output.

### SUMMARY

An answer attribution system includes a generative text model, a text decomposition model, and a natural language inference model. The answer attribution system receives a question and one or more documents. The generative text model generates an answer (e.g., including one or more words) based on the question that requests formulation of the answer relying on the content of the document. Further, the text decomposition model decomposes the answer into a plurality of answer tokens (e.g., words or phrases). The answer tokens, for example, represent different facts, opinions, and propositions expressed in the answer.

The answer attribution system employs the natural language inference model to attribute the plurality of answer tokens to corresponding document tokens (e.g., words and/or phrases) of the one or more documents. To do so, the answer attribution system passes the one or more documents with the document tokens, the question, and the answer with the answer tokens through the natural language inference model via a forward pass. The natural language inference model extracts hidden state representations of the tokens to match the answer tokens to document tokens to perform attribution via a cosine similarity matrix. The answer attribution system then generates one or more annotated documents including visual indications associating the answer tokens with the corresponding document tokens.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ techniques described herein for attribution in contextual question answering using machine-learning hidden states.

FIG. 2 depicts a system in an example implementation showing operation of an answer attribution system to generate an annotated document including attributions of decomposed answer tokens to corresponding document tokens of one or more documents.

FIG. 3 depicts a system in an example implementation showing operation of an answer attribution system to identify extracted answer tokens and attribute token spans to document tokens in a document.

FIG. 4 depicts an example user interface for interacting with an annotated document generated by an answer attribution system.

FIG. 5 depicts an example cosine similarity matrix used to attribute answer tokens to one or more document tokens.

FIG. 6 is a flow diagram depicting a procedure in an example implementation for attribution in contextual question answering using machine-learning hidden states.

FIG. 7 shows a flow diagram depicting an algorithm as a step-by-step procedure for training a machine-learning model according to aspects of the present disclosure.

FIG. 8 illustrates an example system that includes an example computing device that is representative of one or more computing systems and/or devices for implementing the various techniques described herein.

### DETAILED DESCRIPTION

### Overview

Large language models (LLMs) are machine-learning models that generate content (e.g., textual content) based on a prompt. By way of example, an LLM receives a prompt as input and generates a natural language answer to the prompt that synthesizes and summarizes information from one or more information sources. For some text generation tasks, however, users often want to know which sources were relied on by the generative text model in generating the answer to verify that the answer is accurate and comes from reliable information sources. Accordingly, answer attribution techniques are often employed with text generation using generative AI, which identifies and presents information sources to the user that support the generated content.

Conventional answer attribution techniques often attribute an answer in its entirety to an information source. This is problematic for long-form, abstract answers, in which a generated answer includes one or more paragraphs having a plurality of sentences, and each sentence potentially contains multiple independently verifiable facts, opinions, and/or propositions. To properly verify that the information source supports a long-form, abstractive answer, a user of a conventional generative system manually matches finer granularity portions of the text (e.g., words or sentences) in the answer to portions of the information source, which is a time-consuming and tedious process.

Moreover, conventional answer attribution techniques fail to efficiently attribute the answer (or portions thereof) to one or more distinct portions of an information source. This is problematic when answers are attributed to content in the information source at a particular granularity (e.g., paragraph-level granularity), and portions of the answer come from different portions. Similarly, other conventional answer attribution techniques segment content at the sentence level, resulting in the smallest distinguishable unit for attribution being a sentence. However, if an answer asks to pinpoint specific elements within a document (e.g., named entities in a contract), these conventional techniques treat the specific element equivalent to a sentence and do not achieve the requested level of granularity.

To overcome the limitations of these conventional techniques, techniques for attribution in contextual question answering using machine-learning hidden states are described herein as implemented by an answer attribution system. In accordance with the described techniques, a generative text model receives a prompt and a document having a plurality of sentences. The generative text model, for example, is an LLM (e.g., a generative pre-trained transformer model) pre-trained to perform various natural language processing tasks, including question or prompt answering. As output, the generative text model generates an answer based on the prompt that requests the generative text model to rely on the document's content in formulating the answer.

Improved attribution is achieved by passing the document through a natural language inference model to preserve its structure. The natural language inference model employs a two-task attribution system based on an observation that in contextual question-answering systems, a comprehensive answer is typically characterized by factual spans replicated verbatim from various segments of the provided context interwoven with “glue text.” As a result, the first task involves identifying tokens within the generated answer (e.g., referred to herein as “answer tokens”) that have been copied from the provided context. The second task delves deeper into the attribution of the identified answer tokens by mapping these answer tokens back to their original positions within the document. For example, the natural language inference model traces the answer tokens back to tokens within the document (e.g., referred to herein as “document tokens”) from which they were copied. In this way, the natural language inference model establishes a mapping from the source document to the generated output, enabling a more nuanced attribution of the generated answer.

For example, the natural language inference model processes a document D, which is represented as a sequence of document tokens (d₁, d₂, . . . , dₙ), a question Q, and an answer A, which is represented as a sequence of answer tokens (a₁, a₂, . . . , aₘ). In one or more implementations, the first subtask is identifying answer tokens for attribution. In this subtask, the natural language inference model identifies a subset of answer tokens in the answer A, which is denoted as Aₐₜₜᵣ⊆A, that involve attribution to document tokens in document D. Mathematically, the attribution is expressed as selecting answer tokens aᵢ∈A that are directly influenced or copied from document D. In one or more implementations, this subset of tokens is limited to those that are verbatim copied from document D.

The second subtask involves token mapping. For each answer token in Aₐₜₜᵣ, the natural language inference model identifies a mapping function ƒ: Aₐₜₜᵣ→D such that for each answer token aᵢ∈Aₐₜₜᵣ, there exists a corresponding document token or sequence of document tokens in document D to which an answer token aᵢ is attributed. The mapping function establishes a connection between the answer tokens in the answer to be attributed and their corresponding document tokens or document token sequences in document D.

Conventional techniques generally use extensive resources and time for training models or retrieval processes, making them less scalable and efficient. In addition, the granularity and attribution precision of conventional techniques are often compromised due to the constraints posed by the retrieval process and the chunk size. In contrast, the described techniques take advantage of an LLM's ability to differentiate between copied and self-generated content by accessing the hidden states of an LLM that represent contextual embeddings of the tokens. This improved attribution greatly improves the trustworthiness and reliability of contextual question-answering systems.

The following discussion describes an example environment that employs the techniques described herein. Example procedures are also described as performable in the example environment and other environments. Consequently, the performance of the example procedures is not limited to the example environment, and the example environment is not limited to the performance of the example procedures.

### Example Question Answering and Attribution Environment

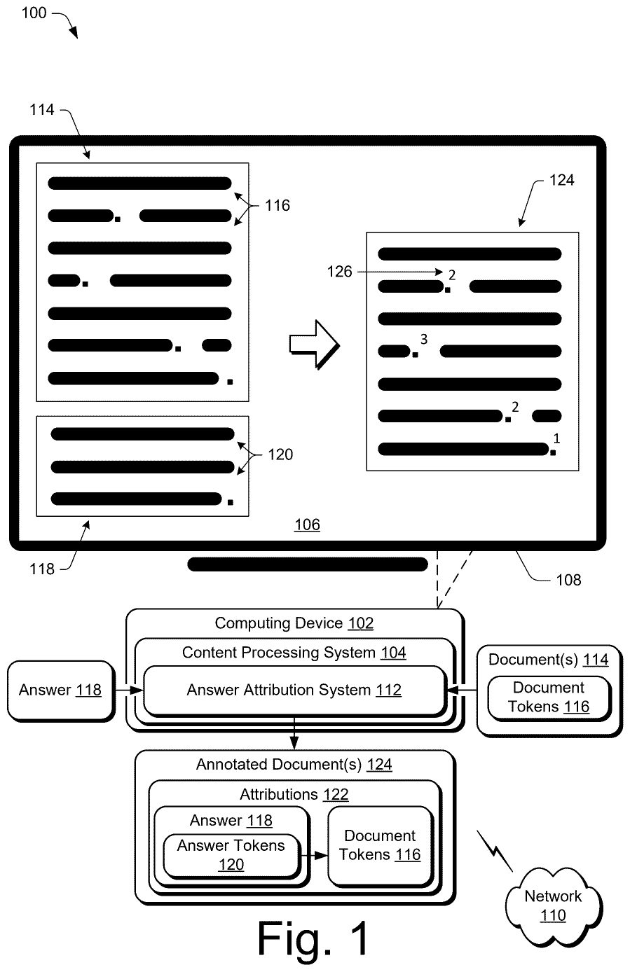

FIG. 1 illustrates an environment 100 in an example implementation that is operable to employ techniques described herein for attribution in contextual question answering using machine-learning hidden states.

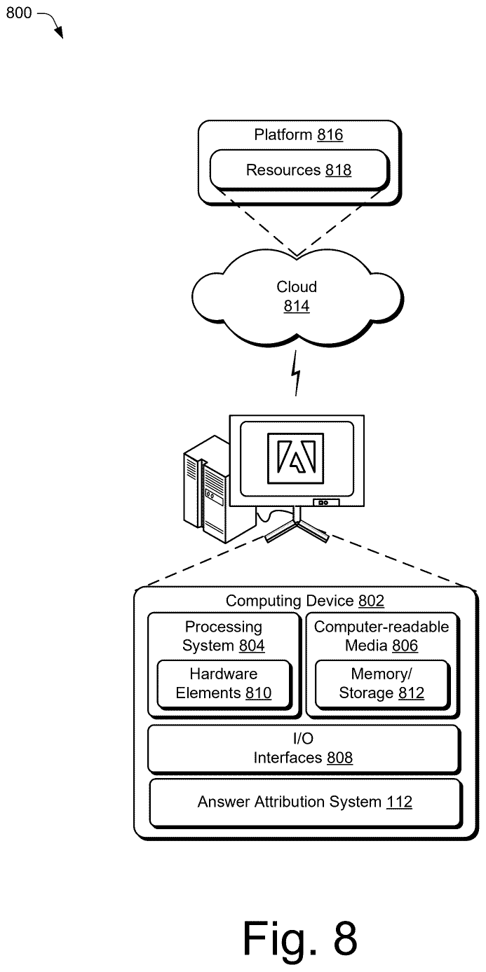

The illustrated environment 100 includes a computing device 102, which is configurable in various ways. The computing device 102, for instance, is configurable as a desktop computer, a laptop computer, a mobile device (e.g., assuming a handheld configuration such as a tablet or mobile phone as illustrated), and so forth. Thus, computing device 102 ranges from full-resource devices with substantial memory and processor resources (e.g., personal computers and game consoles) to a low-resource device with limited memory and/or processing resources (e.g., mobile devices). Additionally, although a single computing device 102 is shown, the computing device 102 is also representative of a plurality of different devices, such as multiple servers a business utilizes to perform operations “over the cloud,” as described in FIG. 8.

The computing device 102 is illustrated as including a content processing system 104. The content processing system 104 is implemented at least partially in hardware of the computing device 102 to process and transform digital content. Such processing includes creation of the digital content, modification of the digital content, and rendering of the digital content in a user interface 106 for output, e.g., by a display device 108. Although illustrated as implemented locally at the computing device 102, functionality of the content processing system 104 is also configurable as whole or part via functionality available via the network 110, such as part of a web service or “in the cloud.”

An example of functionality incorporated by the content processing system 104 to process the digital content is illustrated as an answer attribution system 112. As shown, the answer attribution system 112 receives, as input, one or more documents 114 having a plurality of document tokens 116, and an answer 118 formulated from content of the one or more documents 114. By way of example, a generative text model generates an answer 118 to a prompt, and the answer 118 often includes one or more sentences and/or paragraphs. In accordance with the described techniques, the answer attribution system 112 employs a text decomposition model to decompose the answer 118 into a plurality of answer tokens 120.

The text decomposition model tokenizes the raw text of the document 114 and the answer 118 into smaller and more-manageable units (e.g, tokens). Tokens (e.g., the answer tokens 120 and document tokens 116) are generally individual words, punctuation marks, or sub-word units (e.g., prefixes or suffixes). In other implementations, tokenization occurs at the character level or subword level.

In one or more implementations, the answer attribution system 112 employs a natural language inference model to generate attributions 122 attributing the answer tokens 120 to corresponding document tokens 116 of the one or more documents 114. Generally, “attributing” an answer token 120 to a document token 116 means that the document token 116 is copied into the answer 118. In other implementations, attributing an answer token 120 to a document token 116 means that the document token 116 provides evidentiary support for and/or additional details regarding the answer token 120. As part of this, the natural language inference model generates a cosine similarity matrix measuring a degree to which the answer tokens 120 are inferable by or copied from individual document tokens 116 of the document 114. As shown in the illustrated example, the answer attribution system 112 generates one or more annotated documents 124 that include visual indications 126 of the attributions 122.

Conventional answer attribution techniques often attribute an answer in its entirety to a document (or portions thereof), and fail to efficiently attribute an answer to particular document tokens (e.g., words, phrases, or sentences) of a document. By decomposing the answer 118 into a plurality of answer tokens 120 and attributing the answer tokens 120, the described techniques enable a user to more efficiently verify that long-form, abstractive answers 118 are supported by the provided document 114. Moreover, the described techniques enable attribution of answer tokens 120 to combinations of document tokens 116 with increased computational efficiency by adopting a strategy that utilizes the inner representations of tokens in LLMs without involving additional training or fine tuning.

The answer attribution system 112 accesses the hidden state representations of tokens (e.g., document tokens 116 and answer tokens 120) produced during the inference stage of LLMs. By leveraging these contextual cues associated with the tokens, the answer attribution system 112 matches answer tokens 120 of the answer 118 to document tokens 116 of the document 114.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Document Decomposition and Attribution Features

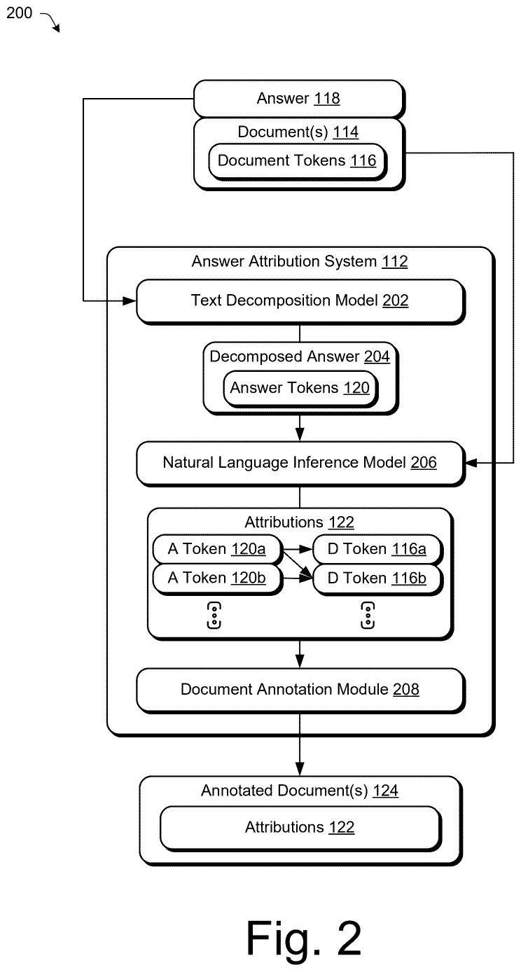

FIG. 2 depicts a system 200 in an example implementation showing operation of an answer attribution system to generate an annotated document including attributions of decomposed answer tokens to corresponding document tokens of one or more documents. As shown, the answer attribution system 112 receives one or more documents 114 having a plurality of document tokens 116, and an answer 118 formulated from content of the document 114. Although techniques are described herein in which the answer attribution system 112 attributes answer tokens 120 of the answer 118 to tokens 116 in the document 114, it is to be appreciated that the described techniques are applicable to attributing answer tokens 120 of the answer 118 to different granularities of textual content in document 114, e.g., individual words, portions of sentences, paragraphs, passages, and/or pages.

Answer 118 is a long-form, abstractive answer in one or more implementations. For instance, in contrast to a short-form answer (e.g., one word or phrase), answer 118 is a multi-sentence paragraph or a multi-paragraph passage. Further, in contrast to an extractive answer (e.g., a word or phrase extracted directly from document 114), a sentence of answer 118 summarizes and synthesizes information from multiple portions of document 114 in natural language. Moreover, the answer attribution system 112 employs a post-hoc attribution technique in which the answer 118 is generated first, and thereafter, the answer 118 is decomposed and attributed to the document tokens 116 of document 114. Given this, the described techniques apply to answers 118 generated manually by a human or automatically by a question-answering system, e.g., ChatGPT.

In particular, answer 118 is provided as input to a text decomposition model 202, which is a machine-learning model or processing device, that has been trained or programmed to decompose answer 118 into answer tokens 120. In one implementation, the text decomposition model 202 is specifically trained to associate the answer tokens 120 to different facts, opinions, and propositions expressed in the textual content. As used herein, the term “machine-learning model” refers to a computer representation that is tunable (e.g., trainable) based on inputs to approximate unknown functions. By way of example, the term “machine-learning model” includes a model that utilizes algorithms to learn from and make predictions on known data by analyzing the known data to generate outputs that reflect patterns and attributes of the known data.

According to various implementations, such a machine-learning model uses supervised, semi-supervised, unsupervised, reinforcement, continuous, interactive, and/or transfer learning. For example, a machine-learning model is capable of including, but is not limited to, clustering, decision trees, support vector machines, linear regression, logistic regression, Bayesian networks, random-forest learning, dimensionality reduction algorithms, boosting algorithms, artificial neural networks (e.g., fully-connected neural networks, deep convolutional neural networks, or recurrent neural networks), deep learning, etc. By way of example, a machine-learning model makes high-level abstractions in data by generating data-driven predictions or decisions from the known input data.

As shown, the text decomposition model 202 receives the answer 118 as input and outputs a decomposed answer 204 that includes the answer tokens 120. The decomposed answer 204 is provided to a natural language inference model 206, which, for example, is a machine-learning model that has been trained to receive a premise and a hypothesis, and output attributions 122 indicating portions of document 114 (e.g., document tokens 116) that correspond to answer tokens 120 in the answer 118. For instance, the answer tokens 120 correspond to the hypotheses, while the document tokens 116 in document 114 correspond to the premises.

The natural language inference model 206 is designed based on the observation that in contextual question answering using machine-learning models (e.g., LLMs), answers typically include factual spans replicated verbatim (or near verbatim) from various segments of the provided context and interwoven with “glue text” or filler words. Building on this observation, the natural language inference model 206 dissects the attribution task into two interconnected subtasks. The first subtask involves identifying answer tokens 120 within the answer 118 that have been (directly) copied from the provided context (e.g., document 114). The second subtask delves deeper into the attribution and involves mapping these answer tokens 120 back to their original positions within document 114. In this way, the natural language inference model 206 establishes an information flow from the source document or context (e.g., document 114) to the generated output (e.g., answer 118) to generate a more nuanced understanding of the context generation process.

Using the natural language inference model 206, the answer attribution system 112 generates attributions 122 of the answer tokens 120 to corresponding document tokens 116 of document 114. Given a particular answer token 120, for instance, the natural language inference model 206 generates links between a particular answer token 120 and respective document tokens 116. For example, the answer token 120a is attributable to multiple document tokens 116a, 116b, while the answer token 120b is attributable to one document token 116b.

As shown, the attributions 122 are received by a document annotation module 208, which is representative of functionality for generating one or more annotated documents 124, including visual indications of the attributions 122. By way of example, the document annotation module 208 generates the annotated document 124 by adding the answer tokens 120 to the document 114 and marking each of the answer tokens 120 with a different visual indication. Further, the document annotation module 208 marks respective document tokens 116 with the visual indication of the one or more answer token 120 to which the respective document tokens 116 are matched.

In one example, the annotated document 124 is annotated in a “footnote” format, in which the answer tokens 120 are numbered, and the document tokens 116 are marked with numbers assigned to the answer tokens 120 with which the document tokens 116 are matched. Additionally, or alternatively, the annotated document 124 is annotated in a “color-coded” format in which the answer tokens 120 are highlighted with different colors, and the document tokens 116 are highlighted with colors assigned to the answer tokens 120 with which the document tokens 116 are matched.

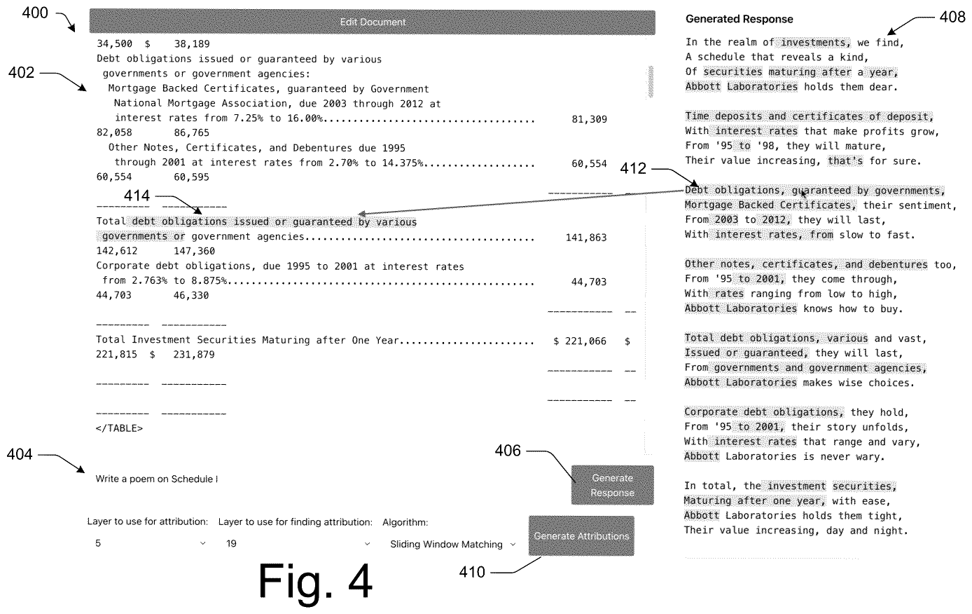

FIG. 4 depicts an example user interface 400 for interacting with an annotated document 124 generated by the answer attribution system 112. As shown in FIG. 4, the user interface 400 includes a first window 402 that includes a document 114, which is illustrated in this example as a financial table describing the debt obligations of a company. In a second window 404, the user provides a question or task for a generative text model: “Write a poem on Schedule 1.” The user interface 400 includes a first user interface (UI) element 406 that allows the user to “generate response” to obtain an answer 118 to the question. The generative text model generates the answer 118, which is displayed in a third window 408 of the user interface 400.

Once the answer is generated, the user selects a second UI element 410 to “generate attributions” to identify extracted answer tokens 120 in the answer 118. In one implementation, user interface 400 visually indicates answer tokens 120 using highlighting and makes these words or phrases clickable. For example, when the user selects “debt obligations” (e.g., UI element 412) in the generated answer 118 within the third window 408, the corresponding attribution or document token 116 is highlighted as UI element 414 in the first window 402. As shown, the answer attribution system 112 visually maps portions of a generated LLM response to the corresponding portions of the source document providing support. It is to be appreciated, however, that any one or more of a variety of visual indications are employable by the document annotation module 208 to visually distinguish the answer tokens 120 and visually indicate correspondence with the document tokens 116.

Although techniques are described herein as attributing portions of the answer 118 to textual portions of the one or more documents 114, it is to be appreciated that the described techniques are applicable to attribute portions of the answer 118 to different modalities of content in the document 114, e.g., image content, video content, and audio content. One example of this functionality includes leveraging one or more machine learning models to convert image content, video content, and audio content to textual summaries. In an example of image-to-text conversion, the answer attribution system 112 provides images from the one or more documents 114 to an image captioning model, examples of which include a Show and Tell Model, a Show, Attend, and Tell Model, and a Bottom-Up and Top-Down Attention Model. Further, the image captioning model generates captions for each of the images in the document 114.

In an example of video-to-text conversion, the answer attribution system 112 employs a pre-trained video-to-text model (e.g., VideoBERT) that has been refined for the task of generating textual video summaries. For instance, the pre-trained video-to-text model receives training data in the form of videos paired with ground truth summaries. Using supervised learning, the pre-trained video-to-text model learns to output video summaries for videos that reflect patterns present in the training data. Given this, the video-to-text model generates textual summaries of the videos in the document 114. In an example of audio-to-text conversion, the answer attribution system 112 transcribes audio (e.g., in the form of speech) to text. Further, the answer attribution system 112 prompts a pre-trained large language model, such as ChatGPT, to summarize the transcribed speech to in accordance with a particular size, e.g., 200 words or less.

In accordance with these examples, the image captions, video summaries, and transcribed speech summaries are used as additional premises for the natural language inference model 206 to evaluate. When an image caption, video summary, or transcribed audio summary is identified as a premise that supports an answer token 120 of the decomposed answer 204, the one or more annotated documents 124 include visual indications marking the corresponding image, the corresponding video, or the corresponding audio file as associated with the answer token 120.

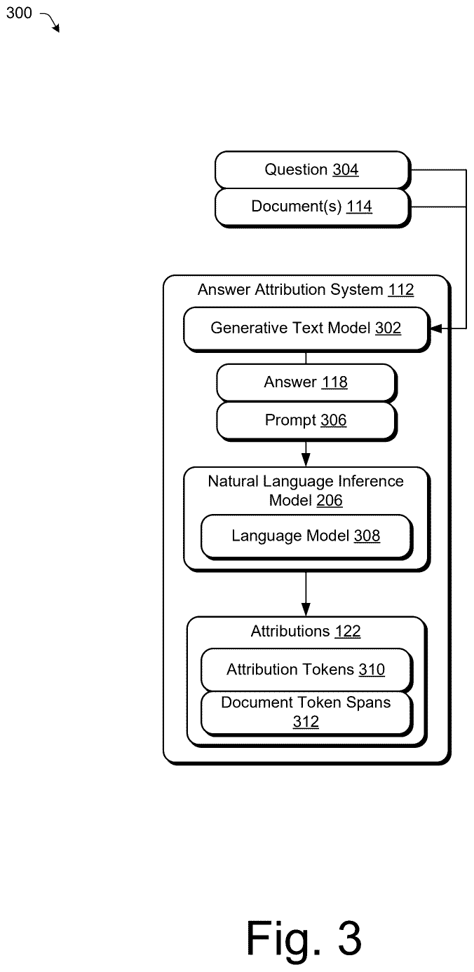

FIG. 3 depicts a system 300 in an example implementation showing operation of an answer attribution system to identify extracted answer tokens and attribute them to document token spans. As shown, the answer attribution system 112 includes a generative text model 302 that receives the document 114 and a question 304. The generative text model 302 is a large language model (LLM) that is pre-trained to perform various natural language processing (NLP) tasks. Examples of the machine-learning generative text model 302 include but are not limited to generative pre-trained transformer (GPT) models, bidirectional encoder representations from transformers (BERT) models, robustly optimized BERT approach models (RoBERTa) models, and text-to-text transfer transformer (T5) models.

Here, the question 304 requests the model 302 to rely on content of the document 114 in formulating an answer 118 to the question 304. In one implementation, the model 302 generates a long-form, abstractive answer 118. In other words, the generative text model 302 employs an abstractive, source-restricted question-answering technique in which the answer 118 is given in natural language, summarizing and synthesizing information from the provided document 114. Examples of the content relied on by the generative text model 302 include plain language text (e.g., paragraphs), document headers, tables, footnotes, figures, images, and lists of document 114, to name just a few. This question-answering technique contrasts with extractive question-answering techniques in which portions of document 114 are extracted verbatim as the answer 118, and source-unrestricted question-answering techniques in which answers 118 are generated based on an unrestricted knowledge corpus, e.g., the internet. It is to be appreciated, however, that the described attribution techniques are extendable to extractive question-answering and source-unrestricted question-answering techniques as well.

In accordance with the described techniques, the text decomposition model 202 receives the answer 118 and a prompt 306. Given a language model 308, denoted as M, the natural language inference model 206 constructs the prompt 306 P by concatenating the document D 114, represented as a sequence of document tokens 116 (d₁, d₂, . . . , dₙ), the question 304 Q, and the answer A 118, represented as a sequence of answer tokens 120 (aᵢ, a₂, . . . , aₘ). The concatenation is formally expressed as P=D+Q+A, where ‘+’ denotes the concatenation operation.

The natural language inference model 206 then passes the prompt 306 P to the language model 308 M in a forward pass to obtain hidden-layer representations for each token (e.g., the document tokens 116 and the answer tokens 120) in P. The hidden-layer representations capture the contextual information encoded by the language model for each token. The hidden-layer representation of each token tᵢ for a specific layer l is denoted as

$${h}_{i}^{l} .$$

An illustrative example of this process is provided below.
[INST]
Document:
{document}
Based on the information contained in the document, answer the question with details to the best of your abilities. Think step by step and explain your answer if that will help better understand the answer.
Q: {question}A:
[/INST]
{answer}

In a first subtask, the language model 308 identifies a subset of answer tokens 120 in answer 118 A, which are referred to as attribution tokens 310 and denoted as Aₐₜₜᵣ⊆A, that involve attribution to document tokens 116 in the document D. Mathematically, the attribution tokens 310 are expressed as selecting answer tokens 120 aᵢ∈A that are directly influenced or copied from the document D. In one or more implementations, the attribution tokens 310 are limited to answer tokens 120 that are verbatim copied from the document D. The attribution tokens 310 also include answer tokens 120 that are inferentially supported by the document D in other implementations.

For any specific layer l and for each answer token 120 aᵢ∈A, the language model 308 concludes an answer token 120 aᵢ comes from the document 114 D if there exists a document token 116 dⱼ∈D such that the cosine similarity between

$${h}_{i}^{l} and {h}_{j}^{l}$$

is greater than a threshold θ, which is formally represented as:

$$\begin{matrix}∀ {a}_{i} ∈ A , if ∃ {d}_{j} ∈ D such that \\ Cosine ( {h}_{i}^{l} , {h}_{j}^{l} ) > θ ⇒ {a}_{i} comes from D .\end{matrix}$$

In the second subtask and for each attribution token 310 in Aₐₜₜᵣ, the language model 308 identifies a mapping function ƒ: Aₐₜₜᵣ→D such that for each attribution token 310 aᵢ∈Aₐₜₜᵣ, there exists a corresponding document token 116 or document token span 312 (e.g., a contiguous sequence of document tokens 116) in the document 114 D to which an attribution token 310 aᵢ is attributed. The mapping function establishes a connection between the answer tokens 120 requiring attribution and their corresponding document tokens 116 or document token spans 312 in document D 114.

Given a span S in the answer 118 A to be attributed, the language model 308 computes the average hidden layer representation h_{S} for each token aᵢ∈S as:

$${h}_{s} = \frac{1}{n} {\sum }_{i = 1}^{n} {h}_{i}^{l}$$

The language model 308 uses the average hidden layer representation h_{S} to identify anchor tokens in the document 114 D. For each document token dⱼ∈D, the language model 308 computes the cosine similarity between h_{S} and

$${h}_{j}^{l}$$

and selects document tokens with the highest similarities as anchor tokens, denoted as D_{T}. For each anchor token dₐ∈D_{T}, the language model 308 explores windows of tokens around dₐ, up to a maximum or predetermined length L. The language model 308 then calculates the average hidden layer representation h_{W} for each window Wand identifies the window with the highest similarity to h_{S}. The highest-ranked window is selected as the final attribution 122 for the span S. In cases where the document 114 D is segmented into evidence spans e∈E, the score for each e is the similarity between h_{S} and the best window within e.

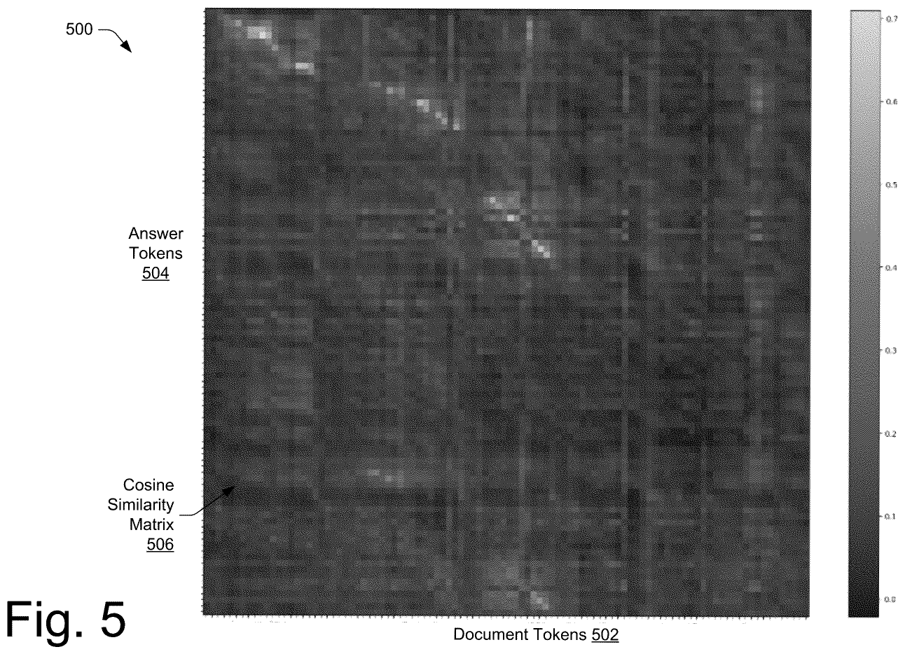

FIG. 5 depicts an example 500 of a cosine similarity matrix used to attribute answer tokens to one or more document tokens. In FIG. 5, the horizontal axis represents document tokens 502 and the vertical axis represents answer tokens 504. The cosine similarity matrix 506 indicates the cosine similarity between the hidden representations of the answer tokens 504 and document tokens 502 at a particular model layer. The cosine similarity matrix 506 is color-coded to illustrate the similarity values visually. Here, the attribution tokens 310 are the answer tokens 504 associated with high similarity values. The document token spans 312 are illustrated as the light-color, diagonal patches in the cosine similarity matrix 506.

### Example Attribution Procedures

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks.

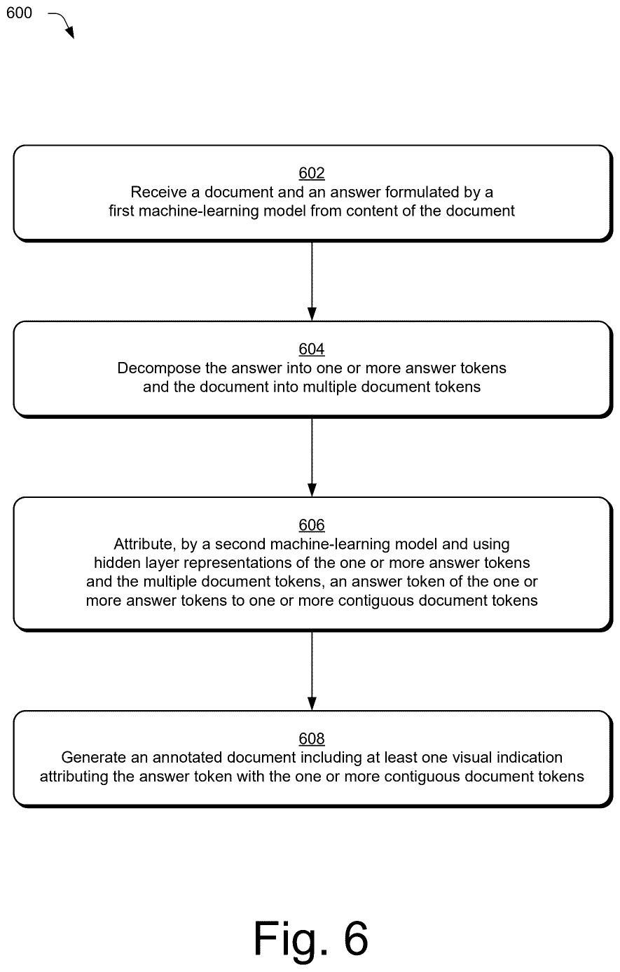

FIG. 6 is a flow diagram depicting a procedure 600 in an example implementation for attribution in contextual question answering using machine-learning hidden states. In procedure 600, a document and an answer formulated by a first machine-learning model from content of the document are received (block 602). By way of example, the answer attribution system 112 uses the generative text model 302 generates the answer 118 from the question 304 based on content in the document 114. In one or more implementations, the generative text model 302 generates the answer 118 based on the question 304 requesting the generative text model 302 to formulate the answer 118 relying just on content from the one or more documents 114. Additionally, or alternatively, the answer 118 is human-generated.

The answer and the document are decomposed into one or more answer tokens and multiple document tokens, respectively (block 604). Each token includes one or more words, word portions, punctuation marks, or alphanumeric characters. By way of example, the text decomposition model 202 generates a representation of the answer 118 as a decomposed answer 204 with a sequence of the answer tokens 120. Similarly, the text decomposition model 202 generates a representation of the document 114 as a sequence of document tokens 116. The answer attribution system 112 then generates the prompt 306 for the language model 308 that concatenates the document 114 (e.g., the sequence of document tokens 116), the question 304 (e.g., user prompt), and the answer (e.g., the sequence of answer tokens 120) together. The prompt 306 is passed through the language model 308 in a forward pass to obtain hidden layer representations of each token.

An answer token is attributed to one or more contiguous document tokens (e.g., document token span 312) of the multiple document tokens (block 606). The attribution is performed by a second machine-learning model (e.g., the language model 308) using hidden layer representations of the answer tokens and document tokens. By way of example, the language model 308 identifies an attribution token 310 among the answer tokens 120 using a cosine similarity matrix 506 of the hidden layer representations of the multiple document tokens and answer tokens. The attribution token 310 corresponds to an answer token 120 where a cosine similarity between the hidden layer representations of the answer token 120 and a document token 116 is greater than a predetermined threshold. This predetermined threshold is set so that the attribution token 310 represents the corresponding answer token 120 verbatim copied from among the multiple document tokens 116.

The language model 308 maps multiple contiguous attribution tokens 310 to multiple contiguous document tokens (e.g., a document token span 312) using the cosine similarity matrix 506. In particular, for a span of the multiple contiguous attribution tokens 310, the language model 308 determines an average hidden layer representation for each attribution token 310 in the span. For each document token 116, the cosine similarity between the average hidden layer representation for the span and the hidden layer representation of the document token 116 is determined. The language model 308 then selects one or more anchor tokens as the document tokens 116 with largest cosine similarities with the average hidden layer representation for the span. For each anchor token, an average hidden layer representation for a window of document tokens centered about the anchor token is determined. The language model 308 identifies the multiple contiguous document tokens attributed to the multiple contiguous attribution tokens as the window of document tokens with a largest cosine similarity with the average hidden layer representation for the span.

An annotated document that includes at least one visual indication attributing the answer token with the one or more contiguous document tokens is generated (block 608). By way of example, the annotated document 124 includes at least one visual indication that is a color coding or interactive link between the answer token 120 and the one or more contiguous document tokens 116.

### Example Training of a Machine-Learning Model

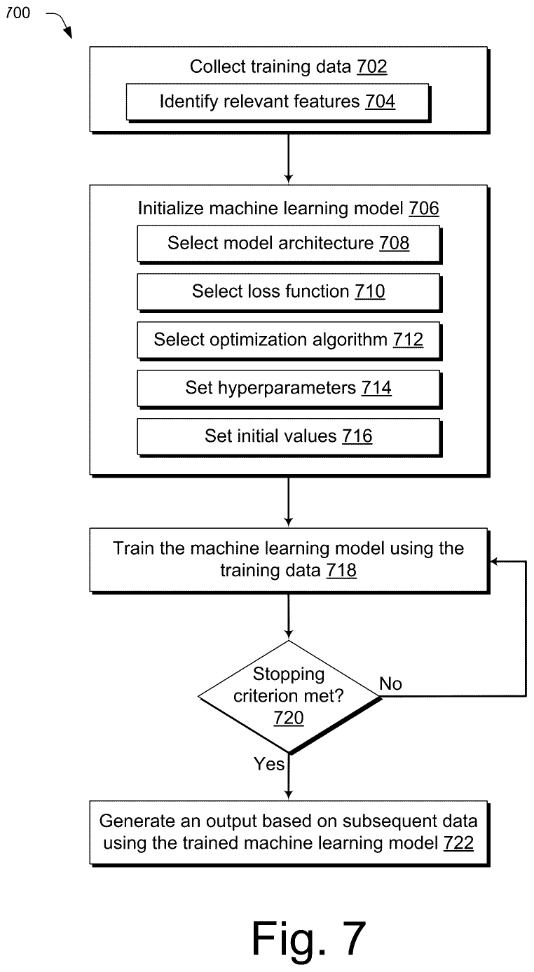

FIG. 7 is a flow diagram depicting an algorithm as a step-by-step procedure 700 in an example implementation of operations performable for training a machine-learning model. In some embodiments, the procedure 700 describes an operation of the training described for configuring the natural language inference model 206 as described with reference to FIG. 2. The procedure 700 provides one or more examples of generating training data, use of the training data to train a machine-learning model, and use of the trained machine-learning model to perform a task.

To begin in this example, a machine-learning system collects training data (block 702) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 704) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 706). Initialization of the machine-learning model includes selecting a model architecture (block 708) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 710). The loss function is utilized to measure a difference between an output of the machine-learning model (i.e., predictions) and target values (e.g., as expressed by the training data) to be used to train the machine-learning model. Additionally, an optimization algorithm is selected (block 712) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 716) examples of which includes initializing weights and biases of nodes to improve efficiency in training and computational resources consumption as part of training. Hyperparameters are also set (block 714) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 718) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 720), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 720), the procedure 700 continues training of the machine-learning model using the training data (block 718) in this example.

If the stopping criterion is met (“yes” from decision block 720), the trained machine-learning model is then utilized to generate an output based on subsequent data (block 722). The trained machine-learning model, for instance, is trained to perform a task as described above and therefore once trained is configured to perform that task based on subsequent data received as an input and processed by the machine-learning model.

### Example System and Device

FIG. 8 illustrates an example system 800 that includes an example computing device representative of one or more computing systems and/or devices usable to implement the various techniques described herein. This is illustrated through the inclusion of the answer attribution system 112. The computing device 802 includes, for example, a server of a service provider, a device associated with a client (e.g., a client device), an on-chip system, and/or any other suitable computing device or computing system.

The example computing device 802, as illustrated, includes a processing system 804, one or more computer-readable media 806, and one or more I/O interfaces 808 that are communicatively coupled, one to another. Although not shown, the computing device 802 further includes a system bus or other data and command transfer system that couples the various components from one to another. For example, a system bus includes any one or combination of different bus structures, such as a memory bus or memory controller, a peripheral bus, a universal serial bus, and/or a processor or local bus that utilizes any of a variety of bus architectures. Various other examples are also contemplated, such as control and data lines.

The processing system 804 represents the functionality of performing one or more operations using hardware. Accordingly, the processing system 804 is illustrated as including hardware elements 810 that are configured as processors, functional blocks, and so forth. This includes example implementations in hardware, such as an application-specific integrated circuit or other logic device formed using one or more semiconductors. The hardware elements 810 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 806 is illustrated as including memory/storage 812. The memory/storage 812 represents memory/storage capacity associated with one or more computer-readable media. In one example, the memory/storage 812 includes volatile media (such as random access memory (RAM)) and/or nonvolatile media (such as read-only memory (ROM), Flash memory, optical disks, magnetic disks, and so forth). In another example, the memory/storage 812 includes fixed media (e.g., RAM, ROM, a fixed hard drive, and so on) and removable media (e.g., Flash memory, a removable hard drive, an optical disc, and so forth). The computer-readable media 806 is configurable in various ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction. In other implementations, the computing device 802 is also configurable to support machine-to-machine (M2M) interactions for which application programmable interfaces (APIs) can be provided by the system 800.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms with various processors.

Implementations of the described modules and techniques are storable on or transmitted across some form of computer-readable media. For example, the computer-readable media includes various media accessible to the computing device 802. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computing device 802, such as via a network. Signal media typically embodies computer-readable instructions, data structures, program modules, or other data in a modulated data signal, such as carrier waves, data signals, or another transport mechanism. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 810. For example, the computing device 802 is configured to implement particular instructions and/or functions corresponding to the software and/or hardware modules. Accordingly, implementation of a module that is executable by the computing device 802 as software is achieved at least partially in hardware, e.g., through the use of computer-readable storage media and/or hardware elements 810 of the processing system 804. The instructions and/or functions are executable/operable by one or more articles of manufacture (for example, one or more computing devices 802 and/or processing systems 804) to implement techniques, modules, and examples described herein.

The techniques described herein are supportable by various configurations of the computing device 802 and are not limited to the specific examples of the techniques described herein. This functionality is also implementable entirely or partially through a distributed system, such as over a “cloud” 814 as described below.

The cloud 814 includes and/or represents a platform 816 for resources 818. Platform 816 abstracts the underlying functionality of hardware (e.g., servers) and software resources of the cloud 814. For example, resources 818 include applications and/or data utilized while computer processing is executed on servers remote from the computing device 802. In some examples, the resources 818 also include services provided over the Internet and/or through a subscriber network, such as a cellular or Wi-Fi network.

The platform 816 abstracts the resources 818 and functions to connect the computing device 802 with other computing devices. In some examples, the platform 816 also serves to abstract scaling of resources to provide a corresponding level of scale to encountered demand for the resources that are implemented via the platform. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method, comprising:
receiving, by a processing device, a document and an answer formulated by a first machine-learning model from content of the document;
decomposing, by the processing device, the answer into one or more answer tokens and the document into multiple document tokens, each token including one or more words, word portions, punctuation marks, or alphanumeric characters;
attributing, by a second machine-learning model and using hidden layer representations of the one or more answer tokens and the multiple document tokens, an answer token of the one or more answer tokens to one or more contiguous document tokens of the multiple document tokens; and
generating, by the processing device, an annotated document that includes at least one visual indication attributing the answer token with the one or more contiguous document tokens.

2. The method of claim 1, wherein the receiving includes generating, using the first machine-learning model, the answer to a question requesting formulation of the answer that relies on the content of the document, the first machine-learning model being a generative text model.

3. The method of claim 2, wherein:
the document is represented as a sequence of the multiple document tokens;
the answer is represented as a sequence of the one or more answer tokens; and
the method further comprises generating, by the processing device, a prompt for the second machine-learning model that concatenates the document, the question, and the answer together.

4. The method of claim 3, wherein the prompt is passed through the second machine-learning model in a forward pass to obtain hidden layer representations of each document token and each answer token.

5. The method of claim 4, wherein the attributing includes identifying an attribution token among the one or more answer tokens using a cosine similarity matrix between the hidden layer representations of the multiple document tokens and the one or more answer tokens, the attribution token corresponding to an answer token where a cosine similarity between the hidden layer representations of the answer token and a document token is greater than a predetermined threshold.

6. The method of claim 5, wherein the predetermined threshold is set so that the attribution token represents a corresponding answer token verbatim copied from among the multiple document tokens.

7. The method of claim 5, wherein the attributing further includes mapping multiple contiguous attribution tokens to multiple contiguous document tokens using the cosine similarity matrix.

8. The method of claim 7, wherein mapping the multiple contiguous attribution tokens to the multiple contiguous document tokens includes:
for a span of the multiple contiguous attribution tokens, determining an average hidden layer representation for each attribution token in the span;
for each document token, determining the cosine similarity between the average hidden layer representation for the span and the hidden layer representation of the document token;
selecting one or more anchor tokens as the document tokens with largest cosine similarities with the average hidden layer representation for the span;
for each anchor token, determining an average hidden layer representation for a window of document tokens centered about the anchor token; and
identifying the multiple contiguous document tokens attributed to the multiple contiguous attribution tokens as the window of document tokens with a largest cosine similarity with the average hidden layer representation for the span.

9. The method of claim 1, wherein the at least one visual indication provides a color coding or interactive link between the answer token and the one or more contiguous document tokens.

10. A system comprising:
a memory component; and
a processing device coupled to the memory component, the processing device configured to:
generate, using a first machine-learning model, an answer to a question requesting formulation of the answer that relies on content of a document;
decompose the answer into one or more answer tokens and the document into multiple document tokens, each token including one or more words, word portions, punctuation marks, or alphanumeric characters;
attribute, by a second machine-learning model and using hidden layer representations of the one or more answer tokens and the multiple document tokens, an answer token of the one or more answer tokens to one or more contiguous document tokens of the multiple document tokens; and
generate an annotated document that includes at least one visual indication attributing the answer token with the one or more contiguous document tokens.

11. The system of claim 10, wherein:
the document is represented as a sequence of the multiple document tokens;
the answer is represented as a sequence of the one or more answer tokens; and
the processing device is further configured to generate a prompt for the second machine-learning model that concatenates the document, the question, and the answer together.

12. The system of claim 11, wherein the prompt is passed through the second machine-learning model in a forward pass to obtain hidden layer representations of each document token and each answer token.

13. The system of claim 12, wherein the processing device is further configured to attribute the answer token to the one or more contiguous document tokens by:
identifying an attribution token among the one or more answer tokens using a cosine similarity matrix between the hidden layer representations of the multiple document tokens and the one or more answer tokens, the attribution token corresponding to an answer token where a cosine similarity between the hidden layer representations of the answer token and a document token is greater than a predetermined threshold.

14. The system of claim 13, wherein the processing device is further configured to attribute the answer token to the one or more contiguous document tokens by mapping multiple contiguous attribution tokens to multiple contiguous document tokens using the cosine similarity matrix.

15. The system of claim 14, wherein the processing device is further configured to map the multiple contiguous attribution tokens to the multiple contiguous document tokens by:
for a span of the multiple contiguous attribution tokens, determining an average hidden layer representation for each attribution token in the span;
for each document token, determining the cosine similarity between the average hidden layer representation for the span and the hidden layer representation of the document token;
selecting one or more anchor tokens as the document tokens with largest cosine similarities with the average hidden layer representation for the span;
for each anchor token, determining an average hidden layer representation for a window of document tokens centered about the anchor token; and
identifying the multiple contiguous document tokens attributed to the multiple contiguous attribution tokens as the window of document tokens with a largest cosine similarity with the average hidden layer representation for the span.

16. The system of claim 10, wherein the at least one visual indication provides a color coding or interactive link between the answer token and the one or more contiguous document tokens.

17. A non-transitory computer-readable medium storing executable instructions, which when executed by a processing device, cause the processing device to perform operations comprising:
receiving a document and an answer formulated by a first machine-learning model from content of the document;
decomposing the answer into one or more answer tokens and the document into multiple document tokens, each token including one or more words, word portions, punctuation marks, or alphanumeric characters;
attributing, by a second machine-learning model and using hidden layer representations of the one or more answer tokens and the multiple document tokens, an answer token of the one or more answer tokens to one or more contiguous document tokens of the multiple document tokens; and
generating an annotated document that includes at least one visual indication attributing the answer token with the one or more contiguous document tokens.

18. The non-transitory computer-readable medium of claim 17, wherein:
the document is represented as a sequence of the multiple document tokens;
the answer is represented as a sequence of the one or more answer tokens; and
the non-transitory computer-readable medium stores additional executable instructions, which when executed by the processing device, cause the processing device to perform additional operations comprising:
generating a prompt for the second machine-learning model that concatenates the document, a question answered by the first machine-learning model to generate the answer, and the answer together; and
passing the prompt through the second machine-learning model in a forward pass to obtain hidden layer representations of each document token and each answer token.

19. The non-transitory computer-readable medium of claim 18, wherein the attributing includes identifying an attribution token among the one or more answer tokens using a cosine similarity matrix between the hidden layer representations of the multiple document tokens and the one or more answer tokens, the attribution token corresponding to an answer token where a cosine similarity between the hidden layer representations of the answer token and a document token is greater than a predetermined threshold.

20. The non-transitory computer-readable medium of claim 19, wherein the attributing further includes mapping multiple contiguous attribution tokens to multiple contiguous document tokens using the cosine similarity matrix by:
for a span of the multiple contiguous attribution tokens, determining an average hidden layer representation for each attribution token in the span;
for each document token, determining the cosine similarity between the average hidden layer representation for the span and the hidden layer representation of the document token;
selecting one or more anchor tokens as the document tokens with largest cosine similarities with the average hidden layer representation for the span;
for each anchor token, determining an average hidden layer representation for a window of document tokens centered about the anchor token; and
identifying the multiple contiguous document tokens attributed to the multiple contiguous attribution tokens as the window of document tokens with a largest cosine similarity with the average hidden layer representation for the span.
